(19) United States
(12) Patent Application Publication
(10) Pub. No.: US 2010/0172705 A1
(43) Pub. Date: Jul. 8, 2010

(54) METHOD FOR MECHANICAL MACHINING, IN PARTICULAR FOR DRILLING AND TURNING LIGHT ALLOY WHEELS, AND A MECHANICAL MACHINING INSTALLATION OPERATING ACCORDING TO THIS METHOD

(76) Inventor: Roberto Sammartin, Selvazzano Dentro (IT)

Correspondence Address: CASTELLANO PLLC, P.O. Box 1555, Great Falls, VA, 22066, US

(21) Appl. No.: 11/917,382

(22) PCT Filed: Jun. 22, 2005
(86) PCT No.: PCT/IT05/00361

§ 371 Date: Dec. 13, 2007

(51) Int. Cl. B23Q 3/18; B23B 35/00; B23B 5/28; B23B 5/34

(52) U.S. Cl. 408/1 R; 408/22; 279/2.01

(57) ABSTRACT

A method for mechanical machining, in particular for drilling and turning wheels of light alloy, comprising a step of centring and locking the wheel to be machined prior to the steps of drilling and turning the wheel. In the centring step provision is made for the further steps of arranging a seating device for the wheel comprising a plurality of elements having the form of a circular sector in plan view, coplanar with each other and spaced apart from each other angularly, each of the sectors being movable along a predefined radial direction, the directions intersecting at a common central axis running perpendicularly to the radial directions, each of the sectors having a respective seating surface for a corresponding part of the outer front portion of the wheel arranged in a position facing the sectors, and of moving the plurality of seating sectors along the respective radial directions to suit the outside diameter of the wheel undergoing the step of centring, so that the seating of wheels having different diameters varying within a preselected range of values is obtained on the device. An installation operating according to the above-mentioned method is also described.

### TECHNICAL FIELD

The present invention relates to a method for mechanical machining, in particular for drilling and turning light alloy wheels, according to the preamble to the main claim. The subject of the invention is also a machining installation operating according to the above-mentioned method.

### TECHNOLOGICAL BACKGROUND

The invention falls particularly, though not exclusively, within the specific technical field of mechanical machining operations provided for in the production of vehicle wheels of light alloy, in particular aluminum alloy. It should also be understood that the invention may be applied equally to mechanical machining of other types of mechanical parts, typically characterized by a substantially axially symmetric geometry (for example wheels, brake discs etc).

In this specific field, provision is made for the semi-finished wheel casting to undergo cycles of machining by removal of chips, mainly drilling and turning, the semi-finished part having first been appropriately centred and clamped on suitable workpiece fixtures.

Typically, the industrial field of mechanical machining for the production of light alloy wheels is characterized by high production volumes with fairly short cycle times for machining each individual wheel, placing it within the field of large-scale production requiring high productivity.

At the present day, moreover, in view of the evolution and globalization of markets, considerable flexibility in production is required so that the main purposes include that of providing production lines in which the parts (wheels) can be fed to machining centres in sequences which are almost random (as regards dimensions, type, geometry etc.), with devices capable of recognizing and applying to each individual part fed to the line the most appropriate work cycle, at the same time optimizing machining and tooling times and costs and also responding promptly and effectively to the requirements and demands imposed by the market, with reference in particular to differences in the characteristics of the part and variations in production volume. A further requirement which arises at the same time as this greater flexibility and speed of response imposed by the market is that of being able to alter production cycles economically and rapidly and also effectively, even in areas where it is more complex to have skilled labour available capable of such levels of intervention on the production lines.

Added to this there is also the further requirement at the present day of obtaining ever greater levels of accuracy in dimensions and shape in the production of light alloy wheels, with the objective of reducing if not eliminating the need for subsequent corrective operations to balance the wheel, all of which also advantageously allows a drastic reduction in the use of materials traditionally employed in balancing operations, such as lead, well known for their toxicity and attendant disposal difficulties.

### DESCRIPTION OF THE INVENTION

The main purpose of the invention is therefore to make available a method and an installation for mechanical machining, in particular for drilling and turning light alloy wheels, designed to meet the above-mentioned requirements, at the same time overcoming the limits encountered with reference to the known solutions.

This purpose and also others which will become clear in what follows are achieved by the invention by means of a method and an installation for mechanical machining implemented according to the claims which follow.

### BRIEF DESCRIPTION OF THE DRAWINGS

The characteristics and advantages of the invention will become clear from the following detailed description of a preferred example of embodiment illustrated purely by way of non-limiting example with reference to the appended drawings in which:

FIG. 1 is a block diagram of the main steps in a method of machining according to the present invention,

FIG. 2 is a schematic view in axial section of a wheel in a machining step in the method according to the invention,

FIG. 2A is a view at an enlarged scale of the detail in FIG. 2 marked by the arrow A,

FIG. 3 is a schematic plan view from the top of the seating and centring device in FIG. 2,

FIGS. 4 and 5 are schematic views in axial section of a wheel in the machining step in FIGS. 2 and 3,

FIG. 6 is a view in partial section and at an enlarged scale of a wheel in a further step in the method of machining disclosed by the invention,

FIG. 7 is a schematic view of an installation for mechanical machining operating according to the steps in FIG. 1.

### PREFERRED MODE OF EMBODIMENT OF THE INVENTION

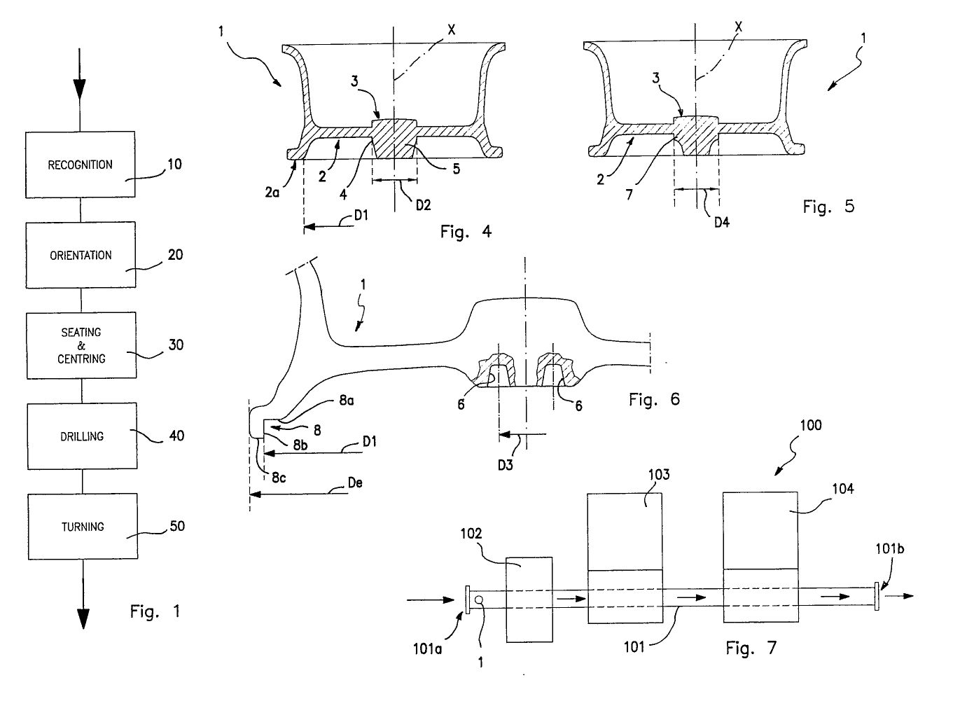

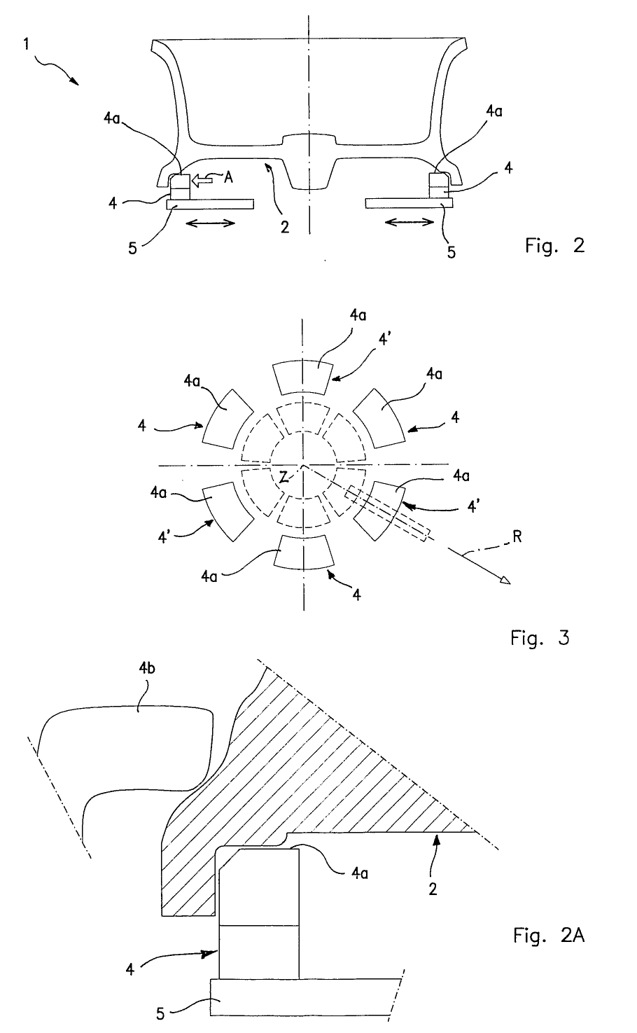

With reference firstly to FIG. 1, the block diagram shown represents the sequence of the main steps in a method for mechanical machining, particularly drilling and turning, of light alloy wheels carried out according to the present invention.

In what follows in the description, specific reference will be made to mechanical machining of a semi-finished wheel, indicated as a whole by the number 1 and shown schematically in the drawings, which, obtained by means of a casting process, is fed to the mechanical machining line on which the main machining operations of drilling, turning and surface finishing, the subject of the method disclosed by the invention, are carried out.

In a first step in the method, identified by the reference number 10, provision is made for the wheel 1 to undergo a process of recognition in which, through the use of detection means (for example vision means with a television camera or similar) or using feeler means, some principal characteristics of the wheel geometry such as for example the height and/or significant diameters are recognized and, in addition or alternatively, some parameters relating to the style or to the form of geometry obtained in the casting process. Once these characteristics are detected, they are compared by a processing unit with the parameters stored in an appropriate databank, into which the information relating to the corresponding machining and tooling times and cycles for each respective and specific type of wheel have previously been input. The result is that by means of the automatic recognition step, the batches of semi-finished wheels or single parts can be fed to the machining lines in substantially random sequences by reason of the fact that, once all the information is received, the machining centre can automatically prepare for machining a specific type of wheel, once the latter has been appropriately recognized. This makes the machining line particularly flexible, achieving high overall productivity rates. In a second step in the method, indicated by 20, provision is made for a first initial orientation of the wheel 1 for subsequent production of the valve hole, the position of which is correlated to the geometry of the wheel, in particular correlated to the form of the front portion 2 of the wheel which extends radially from a central hub 3 (the position of the valve hole therefore depending on the number and size of the spokes extending radially from the hub).

In a subsequent step in the method of machining, indicated by 30, provision is made for the wheel 1 to undergo seating and centring operations carried out with suitable means so that the centred wheel can then be locked in the machining steps provided for, in particular in a subsequent step of drilling.

In the preliminary seating step, provision is made for using a seating device comprising six elements having the form of a circular sector in plan view, all indicated by the number 4, which are coplanar with each other and spaced apart angularly at a regular pitch. Said sectors are guided on respective slides 5 along radial directions, indicated by R, which intersect at a common central axis Z, running perpendicularly to the radial directions R. Each sector 4 has a surface 4a capable of being in seating contact with corresponding parts of the surface of the front portion 2 of the wheel arranged in a position facing the sectors 4. By reason of the surface contact of the wheel on the sectors 4 a seating is obtained at a surface area of substantially annular development. Since the wheel surface seated is a rough casting surface and therefore subject to distortion, in particular due to the heat treatment carried out on the wheel previously, the seating on the annular surface of the sectors 4 enables this distortion to be averaged out, thus determining a median seating plane which is used as a basis for the subsequent centring operations. It should be noted that, because of the provision of sectors 4 guided movably along the respective radial directions R, it is possible to ensure adequate surface seating for wheels having different diameters, varying with in a predefined range of values. Provision is made for example for the seating sectors 4 to be guided, the operation being under numerical control. In general, the result is therefore greater operating flexibility since wheels of different types and sizes can be accommodated on the same seating device without the need for different tooling.

In FIG. 3, solid lines and dashed lines are used to indicate two distinct positioning configurations of the sectors 4 to provide the most suitable seating for a pair of wheels of different diameter.

Provision may also be made for a first group of three sectors 4 (for clarity, identified by 4′ in FIG. 3) to be movable along the corresponding radial directions R until there is lateral contact with the wheel, and in particular with the wheel edge 2a projecting circumferentially from the front portion 2 of the wheel, so as to reach a position where the wheel is centred. The three remaining sectors 4 may for example provide the seating function only and reach radial positions which are in any case at a distance from the wheel edge 2a. The step of centring the wheel, subsequent to seating, may be carried out, as an alternative to what has been described above, using different methods. For example, centring means may be used, for example of the three-element self-centring type, or electronic feelers, which are brought into contact with respective points of a surface of the wheel located, for example, close to the main geometrical axis of the wheel, indicated by X in the drawings. Centring may be carried out on an outer surface (diameter D1 in FIG. 4) or on the central portion or core 5 extended at the central hub 3 (diameter D2 in FIG. 4) or on the rough holes 6 obtained in the casting process and intended for connecting the wheel to the vehicle (diameter D3 in FIG. 6). Alternatively, provision may further be made for the centring diameter D4 to be formed on a surface ring 7 specifically provided for and obtained in the casting process and intended to be removed subsequently by mechanical machining (FIG. 5). The diameter D4 may also be chosen as the standard diameter for a range of wheels differing in type or dimensions, within a predefined range of values, so that centring is substantially independent of the type and size of wheel being machined.

The reference 4b indicates a locking bracket integral with the respective sector 4 and arranged for locking the part once the centred position is reached.

Once centring has been carried out and the wheel 1 has been locked in the centred position, the method provides for a mechanical machining step 40 of drilling, in which the holes 6 for securing the wheel to the vehicle are obtained in the hub 3 of the wheel.

In this step, provision is also made for machining, advantageously by milling, three surfaces 8 (FIG. 6) located at the wheel diameter D1 close to the maximum outside diameter De of the wheel (and arranged at 120° from each other). In particular, each of the three surfaces 8 has a surface portion 8a for seating the wheel in the work-holding devices for subsequent machining operations and a surface portion 8b intended to be in contact with the centring means. Provision may also be made for localized machining of front surface segments 8c as shown in FIG. 6. Since these surfaces 8 are machined at the same time as the holes for attaching the wheel to the vehicle are drilled, they are characterized by high dimensional accuracy correlated to the accuracy of the centring obtained in the preceding step 30. Moreover, because of the preliminary step of seating and centring described above, the surfaces 8a (and the surfaces 8c if provided) are parallel to the median seating plane of the wheel and their use in the step of turning allows highly accurate wheel balance to be obtained.

In a further step 50 in the method, provision is made for turning to be carried out on the wheel 1, in particular turning of the cylindrical wall 9 arranged for mating the wheel with the tyre.

In this step, the centring means are brought into contact with the fixture contact surfaces 8 so as to ensure high centring accuracy and consequently appreciably less imbalance of the wheel.

It should be understood that the machining steps 40 and 50, respectively drilling and turning, may be arranged in reverse order relative to that described above.

With reference to FIG. 7, the number 100 indicates as a whole an installation, shown schematically only, for mechanical machining operating according to the method disclosed by the invention, described previously.

The installation 100 comprises a line 101 for transporting and conveying the semi-finished wheels 1 which extends between an entry station 101a and an exit station 101b.

Further along from the station 101a, the installation comprises a work area 102 arranged for recognition and orientation of the wheel, according to steps 10 and 20 in the method of machining.

The number 103 indicates a machining centre for drilling in which the wheels 1 undergo the step 30 of centring and also the step 40 of drilling. Further along from the drilling centre 103 a machining centre 104 for turning is provided to which the wheels 1 are conveyed for the corresponding step 50 of turning to be executed, at the end of which they are removed to the exit station 101b.

The invention thus achieves the aims proposed, offering the advantages indicated compared with known solutions.

A principal advantage lies in the remarkable flexibility which can be obtained with the method according to the invention because of the fact that the semi-finished wheels can be fed to the mechanical machining line in random sequences, independently of the type of wheel and the size of the batch of parts fed in.

Another advantage lies in high centring accuracy obtained with the method disclosed by the invention which enables particularly small amounts of wheel imbalance to be obtained in the wheel following the machining operations, with a consequent appreciable reduction in the need for subsequent wheel balancing operations.

A still further advantage is that the method and installation disclosed by the invention are designed not to require intervention by specialist personnel for retooling the machining centres.

Another advantage is that using the method disclosed by the invention, with machines equipped with automatic tool magazines, it is possible to work without interruption without ever shutting the installation down except for scheduled maintenance and in case of any breakdowns.

1. A method for mechanical machining, comprising
centering and locking a light alloy wheel which is to undergo machining prior to drilling and turning the wheel, wherein the centring step comprises the further steps of:
arranging a device for seating the wheel comprising a plurality of elements having the form of a circular sector in plan view coplanar with each other and spaced apart from each other angularly, each of said sectors being movable along a predefined radial direction, said directions intersecting at a common central axis running perpendicularly to said radial directions each of said sectors having a respective seating surface for a corresponding part of an outer front portion of the wheel arranged in a position facing said sectors, and
moving said plurality of seating sectors along the respective radial directions to suit the outside diameter of the wheel undergoing the step of centering, so that the seating of wheels having different diameters varying within a preselected range of values is obtained on said device.

2. A method according to claim 1, wherein said circular sector seating elements are spaced apart angularly at a regular pitch about said central axis.

3. A method according to claim 1, wherein said circular sector seating elements are guided along the respective radial directions on respective slides, operating under numerical control.

4. A method according to claim 1 wherein said plurality of elements comprises six seating elements in the form of circular sectors moved in synchronism along the respective radial directions.

5. A method according to claim 1, wherein provision is made for moving at least part of said circular sector seating elements until they come into lateral contact with the wheel to carry out centring of the wheel.

6. A method according to claim 5, in which wherein provision is made for a first group of three circular sector seating elements spaced apart angularly at a regular pitch and a second group of seating sectors angularly arranged in positions alternating with the sectors of the first group, the sectors (V) of said second group being movable radially until they come into contact with the lateral edge of the wheel projecting circumferentially from the outer front surface portion of the wheel, to reach a position of centring of said wheel.

7. A method for mechanical machining according to claim 1, wherein the surface of the front portion of the wheel which is made to seat on said sectors is a rough surface obtained in the process of casting the wheel.

8. A method for mechanical machining according to claim 1 wherein, prior to centring, provision is made for a step of recognition of the semi-finished wheel fed to the machining centre, recognition means being arranged to detect characteristics of the geometry of the wheel, to compare these characteristics with those stored in a databank, so as to identify machining and tooling cycles and times for the wheel recognized, and also to send to the units controlling the machining centre the information necessary for tooling and mechanical machining, so that the semi-finished wheels which are to undergo mechanical machining can be fed to the machining centre in substantially random sequences, the characteristics of each wheel being recognized in the recognition step and the machining centre being controlled and arranged automatically with the machining and tooling cycles for which provision is made for each corresponding wheel recognized.

9. A method for mechanical machining according to claim 8, wherein the characteristics of the wheel significant for the step of recognition of the wheel comprise the height, wheel diameter or type of style relating to the form of wheel obtained in the semi-finished products from the casting process.

10. A method for mechanical machining according to claim 8 wherein, following the recognition step, provision is made for a step of orientation of the wheel to identify the position in which the valve hole is produced in the wheel.

11. A method for mechanical machining according to claim 10, wherein said centring step follows the orientation step and precedes a drilling step in which the holes for securing the wheel to the vehicle are obtained in the wheel hub.

12. A method for mechanical machining according to claim 11, wherein in the steps of centring and locking the wheel arranged for the machining operation of drilling, surfaces located at a wheel diameter close to the maximum outside diameter of the wheel are also made by milling.

13. A method for mechanical machining according to claim 12, wherein said surfaces are made on said front portion of the wheel extending radially from the central hub, at an outer diameter of the wheel.

14. A method for mechanical machining according to claim 12, wherein said surfaces constitute contact points for the contact of centring means capable of centring the part in a machining step of turning the wheel performed subsequent to the drilling step.

15. An installation for mechanical machining, operating according to the method of claim 1.

16. A device for seating and centring light alloy wheels to undergo mechanical machining comprising a plurality of seating elements having the form of a circular sector in plan view, coplanar with each other and spaced apart from each other angularly, each of said sectors being movable along a predefined radial direction, said directions intersecting at a common central axis running perpendicularly to said radial directions, each of said sectors having a respective seating surface for a corresponding part of the outer front portion of the wheel arranged in a position facing said sectors, said seating sectors being movable along the respective radial directions to suit the outside diameter of the wheel undergoing the step of centring, so that the seating of wheels having different diameters varying within a preselected range of values is obtained on said device.

17. A method for mechanical machining according to claim 2, wherein said circular sector seating elements are guided along the respective radial directions on respective slides, operating under numerical control.

18. A method for mechanical machining according to claim 13, wherein said surfaces constitute contact points for the contact of centring means capable of centring the part in a machining step of turning the wheel performed subsequent to the drilling step.
